(19) United States
(12) Patent Application Publication
(10) Pub. No.: US 2020/0307457 A1
(43) Pub. Date: Oct. 1, 2020

(54) MIRROR ASSEMBLY FOR A VEHICLE

(71) Applicant: Visteon Global Technologies, Inc., van Buren Township, MI (US)

(72) Inventor: Paul Fredrick Luther Weindorf, Novi, MI (US)

(73) Assignee: Visteon Global Technologies, Inc., Van Buren Township, MI (US)

(21) Appl. No.: 16/831,094

(22) Filed: Mar. 26, 2020

Related U.S. Application Data
(60) Provisional application No. 62/823,969, filed on Mar. 26, 2019.

(51) Int. Cl. B60R 1/08; B60R 1/04; B60R 1/12; G02F 1/1335; G02B 5/08; G02B 27/28; G02B 5/30

(52) U.S. Cl. CPC B60R 1/08; B60R 1/04; B60R 1/12; G02F 1/133536; G02B 5/0816; B60R 2001/1215; G02B 5/3025; B60K 2370/77; B60R 2300/8066; G02F 2201/44; G02B 27/28

(57) ABSTRACT

A mirror assembly for a vehicle may be a multi-mode electronic mirror. The mirror assembly may include an active polarizer. The active polarizer may be an active absorptive polarizer. A reflective polarizer may be disposed adjacent to the active polarizer and configured to reflect a first polarization component of light back through the active polarizer. A mirror element may be disposed adjacent to the reflective polarizer and opposite of the active polarizer. The reflective polarizer may be secured to the mirror element. The mirror element may be a partially reflective mirror. A display may be disposed adjacent to the mirror element and distal to the active polarizer.

### CROSS REFERENCE TO RELATED APPLICATIONS

This application claims the benefit of U.S. Provisional Patent Application No. 62/823,969, filed on Mar. 26, 2019, and entitled “MIRROR ASSEMBLY FOR A VEHICLE,” which is incorporated by reference in its entirety in this disclosure.

### BACKGROUND

Vehicles are equipped with electronic rear-view mirrors that allow drivers to see the environment behind the vehicles without turning their heads around. In the vehicular space, electronic-mirrors or e-mirrors have been developed to convey information in a vehicle. An electronic mirror is a display device that allows content to be viewable in the reflective state and to be a display device in the display state.

The rear-view mirror may be a conventional electronic rear-view mirror 50, in accordance with FIG. 1. FIG. 1 illustrates a cross-sectional view of the conventional electronic rear-view mirror 50. The conventional electronic rear-view mirror 50 includes a rotator cell 56. The rotator cell 56 may be a liquid rotator cell. The rotator cell 56 is positioned between a first reflective polarizer 54 and a second reflective polarizer 58. Additionally, an active polarizer 52 is positioned on the first reflective polarizer 54. As such, the active polarizer 52 is proximal to the first reflective polarizer 54 and distal to the second reflective polarizer 58. The conventional electronic rear-view mirror 50 further includes a beam stop element 60. The beam stop element 60 is positioned on a side of the second reflective polarizer 58 that is opposite the rotator cell 56. In relation to the active polarizer 52 and the beam stop element 60, in the cabin of the vehicle, the active polarizer 52 would be closest to the seat, and the beam stop element 60 would be farthest away from the seat.

The conventional electronic rear-view mirror 50 may cause a significant double image, which may detract from a user experience of the occupant. Instead of seeing a single, uniform image, the occupant, such as the driver, may see the significant double image. To the occupant, the significant double image may appear as a significantly blurry image or two images offset from one another. Content-wise, the two images may be the same, such as in shape, size, and color. However, the occupant may perceive either the significantly blurry image or the two images (of the same content) offset from one another.

The significant double image is primarily a byproduct of the first reflective polarizer 54, the rotator cell 56, and the second reflective polarizer 58. The first reflective polarizer 54, the rotator cell 56, and the second reflective polarizer 58 are aligned on a common axis 80. The rotator cell 56 separates the first reflective polarizer 54 from the second reflective polarizer 58 on the common axis 80. The separation, along with refractive properties of the rotator cell 56, may affect the significant double image. This can be attributed to parallax between the first reflective polarizer 54 and the second reflective polarizer 58, which results from the separation and the refractive properties.

FIG. 2 illustrates an example of the significant double image from the conventional electronic rear-view mirror 50. In FIG. 2, incoming light 90 reflects off the first reflective polarizer 54, which results in first reflected light 90′. Additionally, the incoming light 90 ends up reflecting off the second reflective polarizer 58, which ultimately results in second reflected light 90″. Due to refractive properties of the rotator cell 56, an angle of approach to the second reflective polarizer 58 may be different from an angle of approach 70 to the first reflective polarizer 54. However, because of the refractive properties, the first reflected light 90′ may be parallel to the second reflected light 90″.

As shown in FIG. 2, the first reflected light 90′ is offset from the second reflected light 90″. That is primarily due to the rotator cell 56, which includes a separation distance 66 and has refractive properties. The separation distance 66 separates the first reflective polarizer 54 from the second reflective polarizer 58. The separation distance 66, along with the refractive properties of the rotator cell 56, propagates the fact that the reflection point for the first reflected light 90′ does not coincide with the reflection point for the second reflected light 90″. As such, increasing the separation distance 66 would increase the effect of the significant double image. Doing so would further increase the offset distance between the first reflected light 90′ and the second reflected light 90″.

With reference to FIG. 2, here is an example of a sample calculation that utilizes Snell's Law. For the sample calculation, the separation distance 66 is 1 mm. This is a typical value for thickness of a rotator cell. The angle of approach 70 is 15 degrees (15°). 15 degrees (15°) is also a reflectance angle for the first reflected light 90′. As such, the total angle between the incoming light 90 and the first reflected light 90′ is 30 degrees (30°). For the refractive properties, the rotator cell 56 includes an index of refraction. The index of refraction for the rotator cell is set at 1.55. From the above, a refracted light angle 68 is calculated:

sin⁻¹[(1/1.55)*sin(15°)]=9.6°.

From the refracted light angle 68 and the 1 mm separation distance 66, a displacement 64 between the point of reflection for the first reflected light 90′ and the point of reflection for the second reflected light 90″ is calculated:

1 mm*tan(9.6°)=0.169 mm.

Doubling the displacement 64 provides an overall displacement 64′:

0.169 mm*2=0.338 mm

The overall displacement 64′, as shown in FIG. 2, compares the point of reflection on the first reflective polarizer 54 for the incoming light 90 and the first reflected light 90′ to the point of exit on the first reflective polarizer 54 for the second reflected light 90″. The overall displacement 64′ may be the offset amount between the first reflected light 90′ and the second reflected light 90″.

As such, the rotator cell 56, due to the separation distance 66 (e.g., 1 mm) and refractive properties, and the presence of the first reflective polarizer 54 and the second reflective polarizer 58 can yield the significant double image. The significant double image may be perceivable by the occupant, which may detract from the user experience.

### SUMMARY

One or more aspects may include a mirror assembly for a vehicle. The mirror assembly may be a multi-mode electronic mirror. The mirror assembly may include an active polarizer configured to operate in a non-polarization operational state or a polarization operational state. A reflective polarizer is disposed adjacent to the active polarizer. The reflective polarizer is configured to reflect a first polarization component of light back through the active polarizer.

A mirror element is disposed adjacent to the reflective polarizer and opposite of the active polarizer. In one or more aspects, the mirror element is adjustable to reflect an amount of a second polarization component of light back through the reflective polarizer and the active polarizer. In other aspects, the mirror element may include a static condition. In the static condition, the mirror element is configured to reflect a set amount of the second polarization component of light back through the reflective polarizer and the active polarizer. As such, in the static condition, the mirror element may not be adjustable. A controller is connected to the one or more of the active polarizer and mirror element. The controller is configured to adjust one or more of the active polarizer and mirror element between at least a first operational state and a second operational state.

One or more aspects may include a mirror assembly for a vehicle. The mirror assembly may be a multi-mode electronic mirror. The mirror assembly may include a housing and a display disposed in the housing. The display is configured to present content. An active polarizer is configured to operate in a non-polarization operational state or a polarization operational state. A reflective polarizer is disposed adjacent to the active polarizer. The reflective polarizer is configured to reflect a first polarization component of light back through the active polarizer.

A mirror element is disposed adjacent to the reflective polarizer and opposite of the active polarizer. In one or more aspects, the mirror element is adjustable to reflect an amount of a second polarization component of light back through the reflective polarizer and the active polarizer. A controller is connected to the one or more of the active polarizer, mirror element and display, wherein the controller is configured to adjust one or more of the active polarizer, mirror element and display between at least a first operational state and a second operational state.

One or more aspects may include a non-transitory computer-readable storage medium. The non-transitory computer-readable storage medium may include instructions that, when executed by a processor, cause the process to control a mirror assembly. The mirror assembly may be a multi-mode electronic mirror. The instructions may cause the processor to perform the following steps: set an operational state of an active polarizer of the mirror assembly and set a display of the mirror assembly to an on-state or an off-state. In one or more aspects, the instructions may cause the processor to also perform the following step: set reflectance of a mirror element of the mirror assembly.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a cross-sectional view of a conventional electronic rear-view mirror.

FIG. 2 is a diagram of the conventional electronic rear-view mirror of FIG. 1.

FIG. 3 is a perspective view of a multi-mode electronic mirror in accordance with one or more aspects of the disclosure.

FIG. 4 is an exploded perspective view of a multi-mode electronic mirror in accordance with one or more aspects of the disclosure.

FIG. 5 is a cross-sectional view of the multi-mode electronic mirror of FIGS. 3 and 4.

FIG. 6 is a process for controlling the multi-mode electronic mirror of FIGS. 3 and 4.

FIG. 7 is a process for controlling the multi-mode electronic mirror of FIGS. 3 and 4.

FIG. 8 is a schematic view of a system diagram for the multi-mode electronic mirror of FIGS. 3 and 4.

The present disclosure may have various modifications and alternative forms, and some representative aspects are shown by way of example in the drawings and will be described in detail herein. Novel aspects of this disclosure are not limited to the forms illustrated in the above-enumerated drawings. Rather, the disclosure is to cover modifications, equivalents, and combinations falling within the scope of the disclosure as encompassed by the appended claims.

### DETAILED DESCRIPTION

Those having ordinary skill in the art will recognize that terms such as “above,” “below,” “upward,” “downward,” “top,” “bottom,” “forward,” “rearward,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

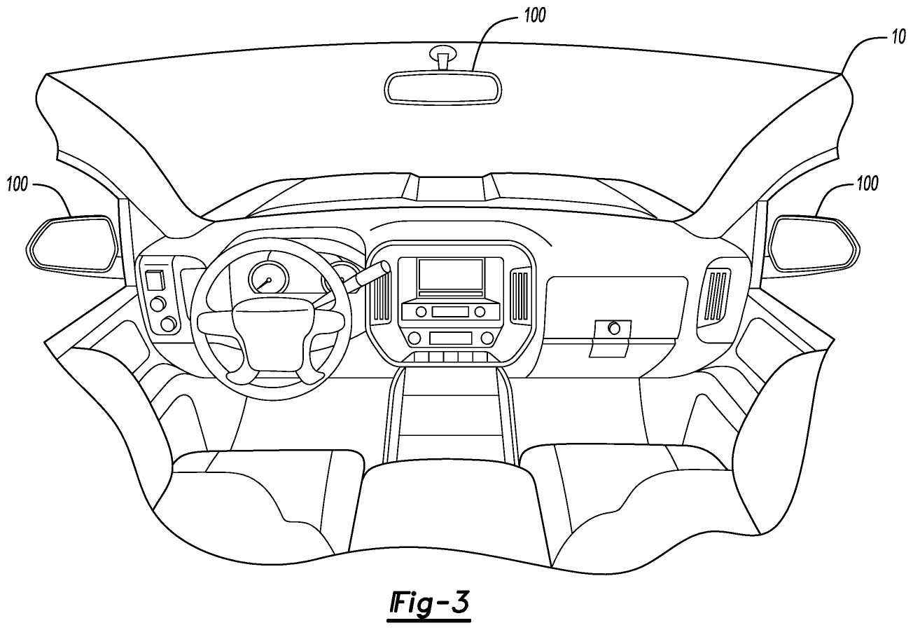

Referring to the Figures, wherein like numerals indicate like parts throughout the several views, FIG. 3 illustrates a perspective view of a mirror assembly 100 in a vehicle environment, which is in accordance with one or more aspects. The mirror assembly 100 may be multi-mode electronic mirror attached to a vehicle 10. For example, the multi-mode electronic mirror 100 may be attached to a front windshield of the vehicle 10. As alternative examples, the multi-mode electronic mirror 100 may be attached to a frame, sub-frame, or body panel of the vehicle 10. The multi-mode electronic mirror 100 may be positioned within a cabin of the vehicle 10 or external to the cabin of the vehicle 10. The multi-mode electronic mirror 100 may be a multi-mode electronic rear-view mirror, a multi-mode electronic side-view mirror, or another type of vehicle display multi-mode electronic rear-view mirror. The multi-mode electronic mirror 100 may be a plurality of multi-mode electronic mirrors.

The multi-mode electronic mirror 100 may be positioned generally forward of a seat in the vehicle 10. This may allow an occupant, such as a driver, to see the multi-mode electronic mirror 100, when the occupant is seated in the seat. The multi-mode electronic mirror 100 may reduce blind spots of the vehicle 10. For example, the multi-mode electronic mirror 100 may have a field of view directed toward a rear of the vehicle 10. The occupant, when seated in the seat, may use the multi-mode electronic mirror 100 to gain an understanding of an environment in rear of the vehicle. This may allow the occupant to remain seated in the seat, facing forward, as opposed to having to turn his/her head toward the rear of the vehicle, in order to gain a similar understanding.

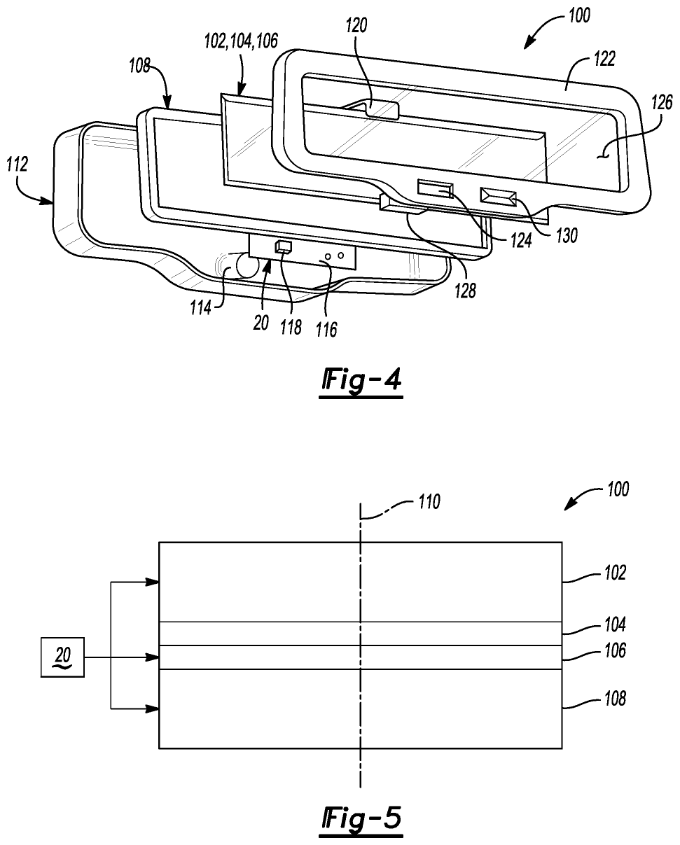

Referring to FIG. 4, the multi-mode electronic mirror may include a housing 112 that may receive and support one or more components of the multi-mode electronic mirror. The housing 112 cooperates with positioning elements 114 to mount the multi-mode electronic mirror 100 to a portion of the interior of vehicle 10 as illustrated in FIG. 3. The multi-mode electronic mirror 100 includes a control circuit or controller, generally referenced by numeral 20, having a printed wire board or printed circuit board (PCB) 116 and one more input devices 118 mounted thereon in electrical communication with the PCB 116. The PCB 116 may include one or more sensors, a processor, and memory, as well as other components, such as a display driver, and a battery.

The controller 20 may be an electrical device housed within the multi-mode electronic mirror 100 or located separate from the multi-mode electronic mirror 100, but still within the vehicle 10 and used to select a mode of operation. The controller 20 may include one or more processors, each of which may be embodied as a separate processor, an application specific integrated circuit (ASIC), or a dedicated electronic control unit. The controller 20 may be any sort of electronic processor (implemented in hardware, software, or a combination of both) installed in a vehicle to allow the various electrical subsystems to communicate with each other. The controller 20 also includes tangible, non-transitory memory (M), e.g., read only memory in the form of optical, magnetic, and/or flash memory.

The controller 20 may be equipped with memory for performing a set of program instructions. The memory may be a non-transitory computer-readable medium. At least one memory including computer-program instructions may be configured to, with at least one processor, cause the controller to carry out a process. Computer-readable and executable instructions embodying the present method may be stored in memory (M) and executed as set forth herein. The executable instructions may be a series of instructions employed to run applications on the controller 20 (either in the foreground or background), and allow either automated control of the vehicular subsystems, or direct control through engagement of an occupant of the vehicle in any of the provided human machine interface (HMI) techniques, such as the one or more input devices 118.

The one or more input devices 118 may include any type of device that provides input the controller 20, such as touch-activated instructions inputted from a touch screen, voice-activated commands input from an audio device, manual inputs, such as a mechanical or electrical stimulus, external inputs from an external device, or the like, that activates, deactivate, or adjusts one or more functions of the multi-mode electronic mirror 100. In one or more non-limiting aspects of the disclosures, the one or more input devices 118 may be a button on the PCB 116 that communicates with the controller 20 to adjust the multi-mode electronic mirror 100 between one or more display modes, such as from a reflective state in a first mode or a mirror only mode and a display state in a second mode or a display only mode, may activate or deactivate a display 108 or adjust an optical property of the multi-mode electronic mirror 100.

The display 108 may be any sort of device capable of generating or configured to generate an image or digitally render information to present to a viewer for display on a projection surface such as an electronic display. For example, in one or more aspects, the display 108 may include a backlight and a projection surface or display element cooperating with the backlight (not shown).

The display 108 may implement a standard display with a variable luminance capability. The display 108 is generally operational to provide visual information to a user. The display 108 may be a light emitting display, such as an organic light emitting diode (OLED) display, liquid crystal display (LCD) a thin-film transistor (TFT) display or other suitable display for the presentation of information. In some aspects, the display 108 may be a TFT display with an active backlight. In other aspects, the display 108 may be an LCD display with the active backlight. Other display technologies may be implemented to meet the design criteria of an application. In a first mode or mirror mode, a brightness of the display 108 may be set to a minimum controlled value. In a second mode or display mode, the brightness of the visual information presented by the display 108 may be controlled based on the rear light intensity and the ambient light intensity.

FIG. 5 illustrates a cross-sectional view of the multi-mode electronic mirror 100, which is in accordance with one or more aspects. The multi-mode electronic mirror 100 includes an active polarizer 102. Adjacent to the active polarizer, the multi-mode electronic mirror includes a reflective polarizer 104. Adjacent to the reflective polarizer 104, the multi-mode electronic mirror includes a mirror element 106. The mirror element 106 may be opposite or positioned on an opposing portion of the reflective polarizer 104 from the active polarizer 102. Adjacent to the mirror element 106, the multi-mode electronic mirror includes a projection device or display 108.

In one or more aspects, the mirror element 106 is adjustable to reflect an amount of a second polarization component of light back through the reflective polarizer 104 and the active polarizer 102. In other aspects, the mirror element 106 may include a static condition. In the static condition, the mirror element 106 is configured to reflect a set amount of the second polarization component of light back through the reflective polarizer 104 and the active polarizer 102. As such, in the static condition, the mirror element 106 may not be adjustable.

A flex element 120 may implement an electrical interface. The flex element 120 is generally operational to operate or energize the one or more layers of the electronic lens assembly 55 in the electronic mirror assembly 42. In completed assemblies, the flex element 120 may electrically connect to the one or more layers of the multi-mode electronic mirror 100.

The housing 112 of the multi-mode electronic mirror 100 may further include a cover surface or bezel 122 at least partially enclosing one or more of the controller 20, active polarizer 102, reflective polarizer 104, mirror element 106 and display 108. The bezel 122 cooperates with the housing 112 and defines at least one aperture 124 or open side therein may be configured to face a viewer of the multi-mode electronic mirror 100 and may be sized to at least partially receive and cooperate with a lens 126. The bezel 122 may also include one or more openings for other elements, switches and/or sensors. The lens 126 may be generally transparent to allow images generated by the display 108 or images reflected by the mirror element 106 to be viewed by the viewer.

A switch or button 128 cooperates with the one or more input devices 18 and extend through the aperture 124 in the bezel 122. The button 128 may be positioned to align with an opening or aperture 124 in the bezel 122. The button 128 may have one or more functions and may be configured as one or more buttons 128. In one or more of the aspects, the switch or button 128 additionally may cooperate with the one or more input devices 118 to adjust the one or more components of the multi-mode electronic mirror 100. A light sensor 130 may also be provided in the bezel 122. The light sensor 130 may record ambient lighting conditions and cooperate with the controller 20 to adjust the luminance settings of the display 108 or the mirror reflectance of the mirror element 106.

Referring now to FIG. 5, the multi-mode electronic mirror 100 is aligned on a common axis 110. On the common axis, the reflective polarizer 104 and the mirror element 106 are positioned between the active polarizer 102 and the display 108. The mirror element 106 may include a semi-transparent reflective surface. The semi-transparent reflective surface of the mirror element 106 may be one of a semi-transparent mirror or a semi-transparent reflective polarizing layer. For example, the mirror element 106 may include a partially reflective surface that provides a mirror surface to reflect images from the rear of the vehicle when the display 108 is inactive. The mirror element 106 may additionally incorporate a partially transparent surface that allows information or content generated on the display 108 to be viewed by a viewer through the mirror element 106. The mirror element layer or mirror element 106 may also be an active polarizer.

The reflective polarizer 104 may be secured to the mirror element 106, such as by an adhesive or other manner or joining or fastening known in the art. For example, the reflective polarizer 104 may be secured to the mirror element 106 through a 3M™ Optically Clear Adhesive, such as 8211 or 8215, from THE 3M COMPANY, with headquarters located in Maplewood, Minn. The reflective polarizer 104 may be in direct contact with the mirror element 106.

In one or more non-limiting aspects, the reflective polarizer 104 may be a reflective polarizer layer formed as a reflective polarizer film. Two or more classes of reflective polarizer materials may be used for the reflective polarizer layer or reflective polarizer 104, including, but not limited to, 3M Reflective Polarizer Mirror (RPM) and 3M Windshield Combiner Film (WCF), both available from THE 3M COMPANY, with headquarters located in Maplewood, Minn. Other reflective polarizer materials having similar properties such as wire grid polarizers may be used to form the reflective polarizer layer or reflective polarizer 104 in other aspects.

The active polarizer 102 may be secured to the reflective polarizer 104, such as by an adhesive or other manner or joining or fastening known in the art. The active polarizer 102 includes a first surface opposite a second surface. The first surface of the active polarizer 102 may be distal to the reflective polarizer 104, and the second surface may be proximal to the reflective polarizer 104. The second surface of the active polarizer 102 may be in direct contact with the reflective polarizer 104. In the vehicle, as compared to the second surface of the active polarizer 102, the first surface of the active polarizer 102 may be closest to the seat.

The display 108 may be secured to the mirror element 106, such as by an adhesive or other manner or joining or fastening known in the art. The display 108 includes a front surface opposite a back surface. The front surface of the display 108 may be proximal to the mirror element 106, and the back surface may be distal to the mirror element 106. The front surface of the display 108 may be in direct contact with the mirror element 106. In the vehicle, as compared to the back surface of the display 108, the front surface of the display 108 may be closest to the seat.

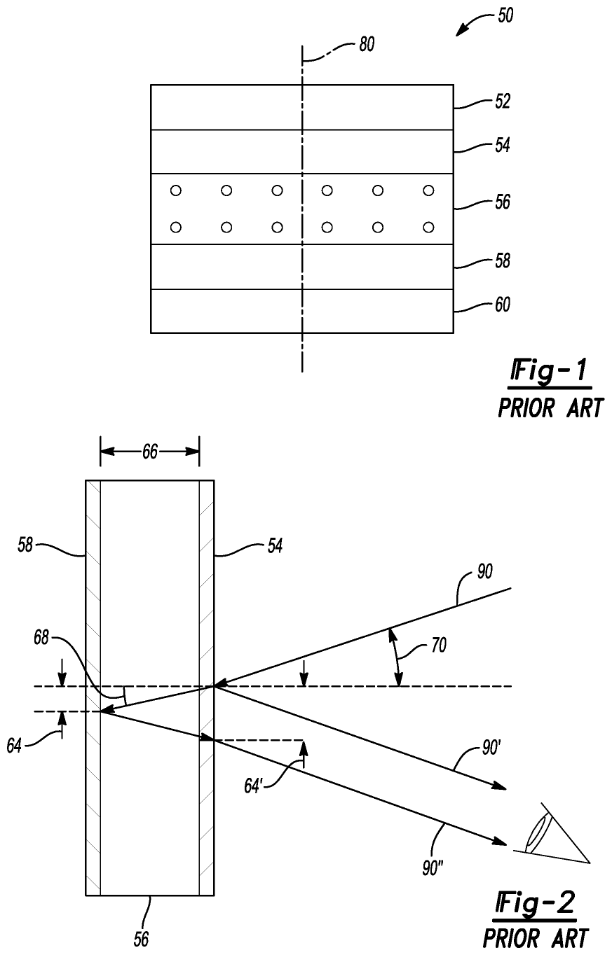

Compared with the conventional electronic rear-view mirror 50 illustrated in FIG. 1, a rotator cell is notably eliminated from the multi-mode electronic mirror 100. Because of the elimination of a rotator cell, a second reflective polarizer is also notably eliminated from the multi-mode electronic mirror 100. The elimination of a rotator cell adjusts performance of the electronic rear-view mirror, particularly in regard to parallax and a double image. This is primarily because the elimination of a rotator cell eliminates a separation distance and refractive properties of a rotator cell. Additionally, compared to the conventional electronic rear-view mirror 50, the elimination of a rotator cell and a second reflective polarizer allows the multi-mode electronic mirror to achieve a smaller overall thickness, a less complex design, and cost savings. For example, thickness of the mirror element 106 may be less than 1 mm (i.e., less than thickness of a rotator cell). Such a thickness for the mirror element 106 may result in the smaller overall thickness. For example, compared to the conventional electronic rear-view mirror 50, overall thickness may be reduced by 4 mm in the multi-mode electronic mirror 100.

Primarily because of the adjacent placement of the reflective polarizer 104 and the mirror element 106, the multi-mode electronic mirror 100 improves performance by reducing a double image. For example, compared to the conventional electronic rear-view mirror, the adjacent placement of the reflective polarizer 104 and the mirror element 106 yields reflection points for incoming light that are closer to one another. This is primarily because the multi-mode electronic mirror 100 does not include a rotator cell. Thus, the multi-mode electronic mirror 100 does not include a separation distance or refractive properties of a rotator cell to propagate a double image.

In the multi-mode electronic mirror 100, the reflective polarizer 104 may be directly secured to the mirror element 106. Primarily because of that direct securement, the multi-mode electronic mirror 100 may reduce the double image down to a minimal level. The minimal level may be achieved when the reflective polarizer 104 is in direct contact with the mirror element 106. In the event that an adhesive or other securement layer is used between the reflective polarizer 104 and the mirror element 106, a thickness of the adhesive or other securement layer would be far less than 1 mm (i.e., far less than a separation distance of a rotator cell). The thickness of the adhesive or other securement layer may be 1 micron to 250 microns, which is far less than 1 millimeter (mm). As such, even in the event that the adhesive or other securement layer is used, the multi-mode electronic mirror 100 outperforms the conventional electronic rear-view mirror 50, particularly in regard to parallax and a double image. Thus, the occupant of the vehicle 10 may perceive a clearer image from the multi-mode electronic mirror 100 than the conventional electronic rear-view mirror 50.

In the multi-mode electronic mirror 100, the mirror element 106 may be a partially reflective mirror adjustable between at least a first operational state and a second operational state. The partially reflective mirror may have a static value for reflectance, such as 0.1. Alternatively, the partially reflective mirror may have dynamic values for reflectance, which may be adapted over a range, such as zero to one. For example, in a first operational state, a first reflectance of zero for the partially reflective mirror element 106 may yield transmission of 100% for the display 108 through the partially reflective mirror element 106. In a second operation state, a second reflectance of one for the partially reflective mirror element 106 may yield transmission of 0% from the display 108 through the partially reflective mirror element 106. It is understood that a variety of reflectance values between zero and one may be used to accomplish the aspects of this disclosure.

The multi-mode electronic mirror 100 may include two or more modes of operations. For example, the multi-mode electronic mirror 100 may include a first mode or mirror only mode. In the mirror only mode, the occupant may be able to perceive a reflection from the mirror element 106. In the mirror only mode, the occupant may be unable to perceive content from the display 108. As another example, the multi-mode electronic mirror 100 may include a display only mode. In the display only mode, the occupant may be able to perceive content from the display 108. The occupant may be unable to perceive a reflection from the mirror element 106. As another example, the multi-mode electronic mirror may include a hybrid mode. In the hybrid mode, the occupant may be able to perceive a reflection from the mirror element 106 and content from the display 108.

The multi-mode electronic mirror 100 may be coupled or connected to a power source, such as a DC battery, within the vehicle. The power source may supply power to the multi-mode electronic mirror 100, including the controller 20. The multi-mode electronic mirror 100 may be coupled or connected to a system within the vehicle 10, such as a navigation system, an infotainment system, a camera system, or a driver assistance system. This may be via a wired connection or a wireless connection with the controller 20.

The controller 20 may be coupled or connected to the active polarizer 102. The active polarizer 102 may be an active absorptive polarizer. The controller 20 may adjust and control an operational state of the active polarizer 102. In one aspect, the controller 20 may control whether the active polarizer is in a first operational state or non-polarization operational state and a second operational state or a polarization operational state. For example, the controller 20 may set the active polarizer 102 such that no polarization occurs, and the light transmitted through the active polarizer is unattenuated. This may be referred to as the first or non-polarization operational state. In the non-polarization operational state, the controller 20 may not send a drive signal to power the active polarizer 102. Because of the lack of power, due to the lack of the drive signal, the non-polarization operational state may also be referred to as an unenergized state.

Comparatively, in the second or polarization operational state, polarization occurs such that light transmitted through the active polarizer 102 is attenuated or polarized. In the polarization operational state, the controller 20 may transmit a drive signal to power or activate the active polarizer 102. Because of the power, due to the drive signal, the polarization operational state may also be referred to as an energized state. The controller may receive an input signal for powering the active polarizer 102. Based on the input signal, the controller 20 may send the drive signal to power the active polarizer 102. The input signal may be sent from a user input device that the occupant may operate, such as a dimmer switch, a sensor, such as one or more light sensors, a system, a circuit, or other electrical device in the vehicle 10.

The controller 20 may be coupled or connected to the display 108. The controller 20 may control the display 108. For example, the controller may control whether the display 108 is in an on-state or an off-state. In the on-state, the controller may receive an input signal for powering the display 108. Similar to the active polarizer 102, the input signal for powering the display 108 may be sent from a user input device that the occupant may operate, such as a dimmer switch, a sensor, such as one or more light sensors, a system, a circuit, or other electrical device in the vehicle 10. Based on the input signal for powering the display 108, the controller 20 may send a drive signal for powering the display 108. From drive signal for powering the display 108, the display 108 may be in the on-state.

Additionally, in the on-state, the controller 20 may receive an input signal for content for the display 108. Based on the input signal for content for the display 108, the controller 20 may send a drive signal for content to the display 108. Similarly, the input signal for content for the display may be sent from a user input device that the occupant may operate, a sensor, a system, a circuit, or other electrical device in the vehicle 10. The drive signal for content may be part of or separate from the drive signal for powering the display 108. In response to the drive signal for content, the display 108 may show content, such as an image taken from a camera system, a real-time video feed from a camera system, graphics and/or images stored in memory for an infotainment system or a navigation system, or other graphical content. In the off state, the controller may not send the drive signal for powering the display or the drive signal for content to the display. As such, the display 108 may be unable to show content in the off state.

The controller 20 may be coupled or connected to the mirror 106 and may control the mirror element 106. As such, the controller 20 may set and adjust reflectance for the mirror element 106. The controller 20 may receive an input signal for reflectance. Similarly, the input signal for reflectance may be sent from one or more input devices 118 illustrated in FIG. 4 that the occupant may operate, such as a dimmer switch, a sensor, such as one or more light sensors, a system, a circuit, or other electrical device in the vehicle 10. Based on the input signal, the controller 20 may send a drive signal for reflectance to the mirror element 106.

Regarding the first or non-polarization operational state, the reflective polarizer 104 may reflect 50% of incoming light. The incoming light may include two polarization components. As such, the incoming light may be unpolarized light. Each polarization component may comprise 50% of the incoming light. The reflective polarizer 104 may be configured to reflect a first polarization component of light back through the active polarizer 102. The reflective polarizer 104 may reflect one polarization component and transmit the other polarization component. Because the reflective polarizer 104 may reflect one of the two polarization components, the reflective polarizer 104 may reflect 50% of the incoming light.

For example, the two polarization components of incoming light may be referred to as an X-polarization component and a Y-polarization component. The X-polarization component may comprise 50% of the incoming light, and the Y-polarization component may comprise the other 50% of the incoming light. In one example, the reflective polarizer 104 may be designed to reflect the X-polarization component and transmit through the Y-polarization component. In another example, the reflective polarizer 104 may be designed to reflect the Y-polarization component and transmit through the X-polarization component.

In the non-polarization operational state, all the incoming light that the reflective polarizer 104 reflects passes back through the active polarizer 102 without any attenuation. As such, when the reflective polarizer 104 reflects 50% of the incoming light, that 50% of light reflected by the reflective polarizer 104 is unattenuated by the active polarizer 102.

Because 50% of the incoming light may be reflected by the reflective polarizer 104, in the non-polarization operational state, the mirror may reflect up to another 50% of incoming light. For example, if the reflective polarizer 104 reflects one of the polarization components of light and transmits through the other polarization component of light, the mirror element 106 would only encounter the other polarization component of light. In this example, because the mirror element 106 only encounters the other component, the mirror element 106, at most, may reflect all the other component. As such, the mirror element 106 may reflect up to 50% of incoming light. Whether the mirror element 106 reflects all, none of, or a portion thereof of the 50% of incoming light depends on reflectance of the mirror element 106. In the first operational state or non-polarization operational state, any incoming light that passes through the reflective polarizer 104 and the mirror element 106 may be absorbed by the display 108. The display 108 may act as a beam stop. This may be due to absorption in the display 108, such as by a color filter (not shown) in the display 108. In the second operational state or polarization operational state, a second reflectance of the mirror element 106 is one such that none of the light passing through the reflective polarizer 104 and the mirror element 106 is absorbed by the display 108.

In the first operational state or non-polarization operational state, the total reflection of incoming light, as a percentage, may be calculated by adding the percentage of incoming light reflected by the reflected polarizer 104 to the percentage of light reflected by the mirror element 106:

% Rnon-polarization=% Rreflective-polarizer+% Rmirror;

where % Rnon-polarization operational state is total reflection of incoming light as a percentage, % Rreflective-polarizer is percentage of incoming light reflected by the reflective polarizer 104, and
% Rmirror is percentage of incoming light reflected by the mirror element 106.

As discussed herein, % Rreflective-polarizer may equal 50%. Additionally, % Rmirror may equal up to 50%. As discussed herein, % Rmirror is dependent on reflectance of the mirror element 106:

% Rmirror=% L*R;

where % L is percentage of incoming light that mirror element 106 encounters, and R is reflectance of mirror element 106.

As discussed herein, the mirror element 106 may encounter 50% of incoming light, as such % L may equal 50%. As to R, reflectance of the mirror may be between 0 and 1. Thus, % Rmirror may be between 0% and 50%.

In the example second operational state or polarization operational state, the active polarizer 102 may transmit one of the polarization components of incoming light. The active polarizer 102 may absorb the other polarization component. The reflective polarizer 104 may be oriented to reflect the other polarization component. Because of the absorption of the active polarizer 102, the reflective polarizer 104 may not encounter any of the other polarization component. As such, the reflective polarizer 104 may not reflect any light in the example second operational state or polarization operational state. For example, the active polarizer 102 may transmit the Y-polarization component, and the reflective polarizer may be oriented to reflect the X-polarization component. The active polarizer 102 may absorb the X-polarization component. In doing so, the reflective polarizer 104 may not encounter any X-polarization component. As such, in the example second operational state or polarization operational state, % Rreflective-polarizer may be 0%. The reflective polarizer 104 may transmit the Y-polarization component. Thus, the total reflection in the second operational state or polarization operational state may depend on reflectance of the mirror element 106.

% Rpolarization=% Rmirror,

where % Rpolarization operational state is total reflection of incoming light as a percentage.

Thus, % Rpolarization operational state may be between 0% and 50%.

Moreover, in the first operational state or non-polarization operational state and second operational state or the polarization operational state, light output from the display may only be attenuated by the mirror element 106. For example, if the display 108 outputs light with only the Y-polarization component, the active polarizer 102 transmits light with the Y-polarization component, and the reflective polarizer 104 is oriented to reflect the X-polarization component (and thus transmit light with the Y-polarization component), then attenuation may only depend on the mirror element 106. This may be expressed by the following equation:

% Tdisplay=100%*(1−R).

Based on the equations herein, the following table shows the effect of reflectance on % Rnon-polarization operational state, % Rpolarization operational state, and % Tdisplay.

| | % Rnon- | | |
|---|---|---|---|
| R | polarization | % Rpolarization | % Tdisplay |
| 0 | 50 | 0 | 100 |
| 0.1 | 55 | 5 | 90 |
| 0.2 | 60 | 10 | 80 |
| 0.3 | 65 | 15 | 70 |
| 0.4 | 70 | 20 | 60 |
| 0.5 | 75 | 25 | 50 |
| 0.6 | 80 | 30 | 40 |
| 0.7 | 85 | 35 | 30 |
| 0.8 | 90 | 40 | 20 |
| 0.9 | 95 | 45 | 10 |
| 1.0 | 100 | 50 | 0 |

As can be seen in the table, when reflectance is zero for the mirror element 106, in the first operational state or non-polarization operational state, 50% of incoming light may be reflected. As discussed, that 50% reflection may result from the reflective polarizer 104. When reflectance is zero for the mirror element 106, in the second operational state or polarization operational state, 0% of the light may be reflected. As discussed, that may be due to the active polarizer 102 absorbing one of the polarization components and transmitting the other polarization component. The reflective polarizer 104 and the mirror element 106 may transmit the other polarization component. That other polarization component may be absorbed by the display 108.

As discussed herein, the controller 20 may set and adjust reflectance of the mirror element 106. For example, the controller 20 may set reflectance at 0.1 for the mirror element 106. In doing so, the polarization operational state may reflect 5% of incoming light. Moreover, the first operational state or non-polarization operational state may reflect 55% of incoming light. Doing so may satisfy a federal regulation or other governmental mandated design constraint. (e.g., Federal Motor Vehicle Safety Standard 111). Other values for reflectance may also satisfy such regulations and constraints.

During nighttime operation of the vehicle 10, it may be desirable to reflect less light from the multi-mode electronic mirror 100 than during daytime operation. One reason for that may be attributed to headlights of trailing vehicles. More particularly, the effect of light from headlights of a trailing vehicle during nighttime operation may have a greater impact on the occupant of the vehicle 10 than during daytime operation. Part of this may be attributed to light levels of the surroundings. For example, during nighttime operation, the outdoor light level may be far less than daytime operation. Alternatively stated, illuminance of the outdoor surroundings may be far less during nighttime operation of the vehicle 10 than daytime operation. Because of that, the effect of light from headlights of a trailing vehicle may have a greater impact during nighttime operation than daytime operation on an occupant of the vehicle 10. As such, it may be desirable to reflect less light to the occupant of vehicle 10, via the multi-mode electronic mirror 100, during nighttime operation than during daytime operation.

It may also be desirable to reflect less light when the surroundings may be similar to nighttime operation. This may even be desirable when the vehicle 10 is in daytime operation. For example, if the vehicle, during daytime operation, enters an unlit or dimly lit parking garage, it may be desirable to treat operation of the multi-mode electronic mirror 100 similarly to nighttime operation. This may mean adjusting the multi-mode electronic mirror 100 to reflect light at similar amounts to the nighttime operation.

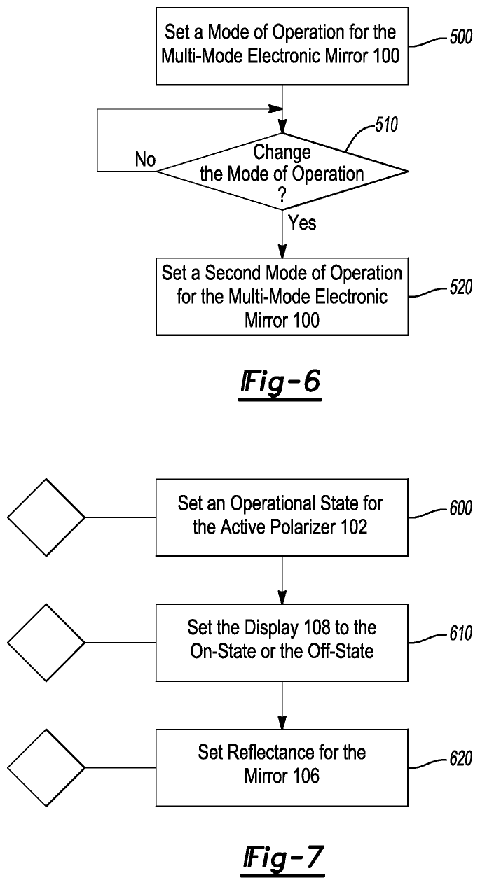

FIG. 6 illustrates a process for the controller 20 of the multi-mode electronic mirror 100 illustrated in FIG. 5, which is in accordance with one or more aspects. The process includes a step 500 for setting a mode of operation of the multi-mode electronic mirror 100. In the step 500, the controller 20 sets the mode of operation. The process includes a step 510 for determining whether to change from the mode of operation. In step 510, the controller 20 determines whether to change from the mode of operation. If the controller determines not to change, then the multi-mode electronic mirror 100 will continue to operate in a first mode of operation. The determination not to change may include a loop back to the step 510. If the controller 20 determines to change, then the process includes a step 520 for setting a second mode of operation for the multi-mode electronic mirror 100. In step 520, the controller 20 sets the second mode of operation. The second mode of operation supersedes the first mode of operation.

FIG. 7 illustrates a process for the controller 20 of the multi-mode electronic mirror 100, which is in accordance with one or more aspects. The process includes a step 600 for setting an operational state of the active polarizer 102. In the step 600, the controller 20 sets the operational state of the active polarizer 102. After setting the active polarizer 102, the controller 20 may further determine whether to change from the operational state. The process includes a step 610 for setting the display to either the on-state or the off-state. In the step 610, the controller 20 sets the display 108 to either the on-state or the off-state. After setting the display 108, the controller 20 may determine whether to change from the selected state—e.g., change from the on-state to the off-state. The process includes a step 620 for setting reflectance for the mirror element 106. In the step 620, the controller 20 sets reflectance for the mirror element 106. After setting the mirror element 106, the controller may determine whether to change from the selected reflectance.

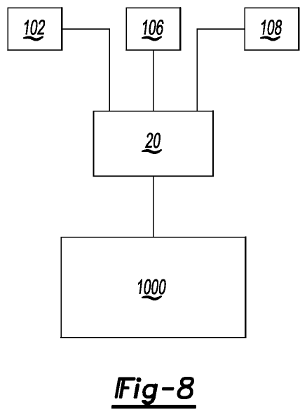

FIG. 8 illustrates a schematic view of a system diagram for the multi-mode electronic mirror 100. From FIG. 8, the controller 20 may be coupled or connected to the active polarizer 102, the mirror element 106, and the display 108. The controller may send one or more drive signals to the active polarizer 102, the mirror element 106, or the display 108. The controller 20 may be coupled or connected to an electrical device 1000. The controller 20 may receive one or more input signals from the electrical device 1000.

The electrical device 1000 may be part of a system within the vehicle 10 shown in FIG. 3, such as a navigation system, an infotainment system, a camera system, or a driver assistance system. For example, the electrical device 1000 may be coupled or connected to a camera of a camera system, such as a rear-view camera system. The electrical device 1000 may send a video feed from the camera to the controller 20. In addition, the controller 20 may send the video feed to the display 108.

The electrical device 1000 may be part of a user input device. For example, the user input device may be a dimmer switch. Through the user input device, the occupant of the vehicle may adjust a mode, state, or optical property associated with the multi-mode electronic mirror 100. For example, the occupant may use the user input device to adjust brightness of the multi-mode electronic mirror 100. In doing so, the electrical device 1000 may send a signal to the controller 20. Moreover, based on the signal, the controller 20 may adjust the multi-mode electronic mirror 100 accordingly.

The electrical device 1000 may be part of a sensor for measuring light levels, such as within the cabin of the vehicle 10. For example, the electrical device 1000 may send a signal from the sensor to the controller 20. The signal may be a reading of a light level in the cabin of the vehicle 10. Additionally, based on the signal, the controller 20 may adjust a mode, state, or optical property associated with the multi-mode electronic mirror 100. This may be by comparing the reading against a reference table that may be stored in memory on the controller or another electrical device. The reference table may include settings for the active polarizer 102, settings for reflectance of the mirror element 106, and settings for the display 108. These various settings may be based on light levels, such as illuminance within the cabin of the vehicle 10. This may provide an automated way to adjust a mode, state, or optical property of the multi-mode electronic mirror 100, which may further improve user experience.

The aspects of the present disclosure generally provide for a plurality of circuits or other electrical devices. All references to the circuits and other electrical devices and the functionality provided by each are not intended to be limited to encompassing only what is illustrated and described herein. While labels may be assigned to the various circuits or other electrical devices disclosed, such labels are not intended to limit the scope of operation for the circuits and the other electrical devices. Such circuits and other electrical devices may be combined with each other and/or separated in any manner based on the type of electrical implementation desired. It is recognized that any circuit or other electrical device disclosed herein may include any number of microcontrollers, processors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform any operation(s) disclosed herein. In addition, any one or more of the electrical devices may be configured to execute a computer-program that is embodied in a non-transitory computer readable medium that is programmed to perform any number of the functions as disclosed.

The detailed description and the drawings or figures are supportive and descriptive of the disclosure, but the scope of the disclosure is defined solely by the claims. While some of the best modes and other aspects for carrying out the claimed teachings have been described in detail, various alternative designs and aspects exist for practicing the disclosure defined in the appended claims.

1. A mirror assembly for a vehicle, the mirror assembly comprising:
an active polarizer, wherein the active polarizer is adjustable between a non-polarization operational state and a polarization operational state;
a reflective polarizer disposed adjacent to the active polarizer, wherein the reflective polarizer is configured to reflect a first polarization component of light back through the active polarizer;
a mirror element disposed adjacent to the reflective polarizer and opposite of the active polarizer, wherein a reflectance of the mirror element is adjustable to reflect an amount of a second polarization component of light back through the reflective polarizer and the active polarizer; and
a controller coupled to the one or more of the active polarizer and mirror element, wherein the controller is configured to adjust one or more of the active polarizer and the mirror element between at least a first operational state and a second operational state.

2. The mirror assembly of claim 1, wherein the controller is configured to adjust the operational state of the active polarizer between:
the first operational state, wherein the first operational state is a non-polarization operational state, wherein light transmitted through the active polarizer is unattenuated; and
the second operational state, wherein the second operational state is a polarization operational state, wherein the controller transmits a drive signal to activate the active polarizer to polarize light transmitted therethrough.

3. The mirror assembly of claim 2, wherein the active polarizer is an active absorptive polarizer for absorbing the first polarization component of light when in the polarization operational state and transmitting the first polarization component of light when in the non-polarization operational state.

4. The mirror assembly of claim 1, further comprising a display disposed adjacent to the mirror element and opposite of the reflective polarizer configured to present content.

5. The mirror assembly of claim 4, wherein the controller is connected to the display and is configured to adjust the display between a first operational state and a second operational state.

6. The mirror assembly of claim 5, wherein the controller is configured to adjust the operational state of the display between:
the first operational state, wherein the first operational state is an on-state, wherein the controller transmits a drive signal to power the display and present content; and
the second operational state, wherein the second operational state is an off-state, wherein the display does not generate content.

7. The mirror assembly of claim 1, wherein the controller is configured to adjust the reflectance of the mirror element between the first operational state and the second operational state to reflect the amount of the second polarization component of light back through the reflective polarizer and the active polarizer.

8. The mirror assembly of claim 1, wherein the controller is configured to adjust the operational state of the mirror element between at least:
the first operational state, wherein a first reflectance of the mirror element is zero such that light passing through the reflective polarizer and the mirror element is absorbed by a display; and
the second operational state, wherein a second reflectance of the mirror element is one such that none of the light passing through the reflective polarizer and the mirror element is absorbed by the display.

9. The mirror assembly of claim 1, wherein the mirror element is a partially reflective mirror.

10. A mirror assembly for a vehicle, the mirror assembly comprising:
a housing;
a display disposed in the housing, wherein the display is configured to present content;
an active polarizer, wherein the active polarizer is adjustable between a non-polarization operational state and a polarization operational state;
a reflective polarizer disposed adjacent to the active polarizer, wherein the reflective polarizer is for reflecting a first polarization component of light back through the active polarizer;
a mirror element disposed adjacent to the reflective polarizer and opposite of the active polarizer, wherein the mirror element includes a reflectance for reflecting an amount of a second polarization component of light back through the reflective polarizer and the active polarizer.

11. The mirror assembly of claim 10, further comprising a controller coupled to the active polarizer wherein the controller is configured to adjust an operational state of the active polarizer between:
a first operational state, wherein the first operational state is the non-polarization operational state, wherein light transmitted through the active polarizer is unattenuated; and
a second operational state, wherein the second operational state is the polarization operational state, wherein the controller transmits a drive signal to activate the active polarizer to polarize light transmitted therethrough.

12. The mirror assembly of claim 10, wherein the active polarizer is an active absorptive polarizer for absorbing the first polarization component of light when in the polarization operational state and transmitting the first polarization component of light when in the non-polarization operational state.

13. The mirror assembly of claim 11, wherein the controller is coupled to the display and configured to adjust an operational state of the display between:
a first operational state, wherein the first operational state is an on-state, wherein the controller transmits a drive signal to power the display and present content; and
a second operational state, wherein the second operational state is an off-state, wherein the display does not generate content.

14. The mirror assembly of claim 11, wherein the controller is coupled to the mirror element and configured to adjust the reflectance of the mirror element between a first operational state and a second operational state to reflect the amount of the second polarization component of light back through the reflective polarizer and the active polarizer.

15. The mirror assembly of claim 11, wherein the controller is coupled to the mirror element and configured to adjust an operational state of the mirror element between at least:
a first operational state, wherein a first reflectance of the mirror element is zero such that light passing through the reflective polarizer and the mirror element is absorbed by the display; and
a second operational state, wherein a second reflectance of the mirror element is one such that none of the light passing through the reflective polarizer and the mirror element is absorbed by the display.

16. The mirror assembly of claim 11, wherein the controller is coupled to the mirror element and configured, wherein the mirror element is configured to reflect a first amount of the second polarization component of light back through the reflective polarizer and the active polarizer and transmit a second amount of the second polarization component of light to the display, and wherein the display is configured to absorb the second amount of the second polarization component of light.

17. A non-transitory computer-readable storage medium including instructions that, when executed by a processor, cause the process to control a mirror assembly, by performing a performing a process, the process comprising:
setting an operational state of an active polarizer of the mirror assembly; and
setting a display of the mirror assembly to an on-state or an off-state.

18. The non-transitory computer-readable storage medium of claim 17, the process further comprising setting the operational state of the active polarizer between:
a first operational state, wherein the first operational state is a non-polarization operational state, wherein light transmitted through the active polarizer is unattenuated; and
a second operational state that supersedes the first operational state, wherein the second operational state is a polarization operational state, wherein the controller transmits a drive signal to activate the active polarizer to polarize light transmitted therethrough.

19. The non-transitory computer-readable storage medium of claim 17, the process further comprising setting the operational state of the display between:
a first operational state, wherein the first operational state is an on-state, wherein the controller transmits a drive signal to power the display and present content; and
a second operational state that supersedes the first operational state, wherein the second operational state is an off-state, wherein the display does not generate content.

20. The non-transitory computer-readable storage medium of claim 17, the process further comprising setting the operational state of the mirror element between:
a first operational state, wherein a first reflectance of the mirror element is zero such that light passing through a reflective polarizer and mirror is absorbed by the display; and
a second operational state that supersedes the first operational state, wherein a second reflectance of the mirror element is one such that none of the light passing through the reflective polarizer and the mirror element is absorbed by the display.
